(19) United States
(12) Patent Application Publication
(10) Pub. No.: US 2024/0405193 A1
(43) Pub. Date: Dec. 5, 2024

(54) ELECTRODE DESIGN FOR AN ELECTROCHEMICAL CELL OF THE PRIMARY LITHIUM TYPE

(71) Applicant: SAFT, Levallois-Perret (FR)

(72) Inventors: Fabrice RENE, Chiré en Montreuil (FR); Catherine LEPILLER, Migne-Auxances (FR); Benjamin LE GUERN, Les Roches Prémarie (FR); Olivier HUCHET, Latresne (FR)

(73) Assignee: SAFT, Levallois-Perret (FR)

(21) Appl. No.: 18/698,133

(22) PCT Filed: Oct. 4, 2022
(86) PCT No.: PCT/EP2022/077502

§ 371 Date: Apr. 3, 2024

(30) Foreign Application Priority Data
Oct. 12, 2021 (FR) FR2110815

(51) Int. Cl. H01M 4/133; H01M 4/02; H01M 4/134; H01M 4/40; H01M 4/58; H01M 50/107

(52) U.S. Cl. CPC H01M 4/133; H01M 4/134; H01M 4/405; H01M 4/582; H01M 50/107; H01M 2004/027; H01M 2004/028

(57) ABSTRACT

An electrochemical cell including a container including an electrochemical spiral bundle including: a positive electrode including an active material selected from among SOCl₂, SO₂, SO₂Cl; CFₓ where x≤1.5; MnO₂, FeS₂, V₂O₅, I₂, Bi₂O₃, Bi₂Pb₂O₅, CuCl₂, CuF₂, CuO, Cu₄O(PO₄)₂, CuS, FeS, MoO₃, Ni₃S₂, AgCl, Ag₂CrO₄, SVO, MO₆S₈, and a mixture of a plurality thereof; a separator; and a negative electrode including an active material made of lithium metal or of a lithium-based alloy. The outer face of the spiral, facing the container, is formed by the positive electrode, and a strip of lithium or of a lithium-based alloy at least partially covers the inner face of the container. The strip pressed against the inner face of the container makes it possible to make use of an outer face of the positive electrode which forms the last turn of the spirally-wound electrode plate group.

### FIELD OF THE INVENTION

The technical field of the present invention is that of primary electrochemical cells comprising a lithium metal or lithium-based alloy anode.

### PRIOR ART

The term “cell” or “electrochemical cell” will be used interchangeably in the following. The term “primary” denotes a non-rechargeable electrochemical cell, also referred to as a battery, as opposed to the term “secondary” which designates a rechargeable electrochemical cell, also called an accumulator.

The family of lithium primary electrochemical cells further comprises primary electrochemical cells with a liquid cathode, also sometimes called catholyte, and primary electrochemical cells with a solid cathode.

Primary electrochemical cells with a liquid cathode, of the Li/SO₂, Li/SOCl₂ and Li/SO₂Cl₂ type are known. The anode (or negative electrode) is made of lithium metal or of lithium alloy. The positive electrode is a porous mass of carbon of large specific surface area, the pores of which contain SO₂, or SOCl₂ or SO₂Cl₂. SO₂ being gaseous at ambient temperature, it is present in the cell in a form dissolved in an organic solvent, such as acetonitrile. SOCl₂ or SO₂Cl₂, being liquid at ambient temperature, they constitute both the solvent of the electrolyte and the cathode of the cell. During the discharge of such a cell, the oxidation of the lithium metal to lithium ions occurs at the anode according to the following reaction:

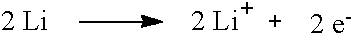

At the positive electrode, reduction of the oxidizing compound occurs in the pores of the carbon mass, the cathodic reaction support. In the case where the oxidant is sulfur dioxide SO₂, the reduction reaction is as follows:

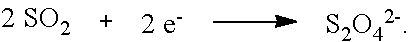

In the case where the oxidant is SOCl₂, the reduction reaction is as follows:

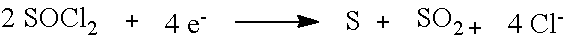

Primary electrochemical cells with a solid cathode of the Li/MnO₂ and Li/CFₓ type are known. The anode is made of lithium metal or of lithium alloy. In discharge at the cathode, Mn^{IV}O₂ must be transformed into LiMn^{III}O₂; CFₓ is transformed into carbon. During discharge, at the anode, like for a primary liquid cathode cell, oxidation of lithium metal to lithium ions occurs. The organic solvents used may be propylene carbonate or dimethoxyethane. The salt used may be chosen from lithium perchlorate LiClO₄, lithium hexafluoroarsenate LiAsF₆, or lithium hexafluorophosphate LiPF₆.

Such electrochemical cells are generally constructed with a spirally-wound electrode assembly.

This spirally-wound construction can take various forms.

Document KR 10-1996543 discloses, for example, a primary lithium-type cell in which only the cathode is in spiral form. Documents CN 109698320, US 2020/0266452 and U.S. Pat. No. 9,748,610 describe constructions in which the cathode, the separator and the anode are superposed and then the assembly is wound to form a spiral.

Generally, a lithium primary cell used at room temperature has a lower negative electrode capacity than that of the positive electrode, this being in order that all the lithium of the negative electrode is consumed at the end of discharge, for safety reasons. However, when these spirally-wound constructions are used for high-temperature applications, in particular for temperatures above 150° C. provision is made to use a greater quantity of lithium in the cell to compensate for the effect of temperature on self-discharge of the anode because the self-discharge phenomenon increases when the cell is used at a temperature greater than 150° C. Thus, with a greater quantity of lithium, the ratio between the capacity of the negative electrode and the capacity of the positive electrode is preferably greater than 1. Since the positive electrode is then the limiting electrode, it is important that its operating performance (yield) be optimized. There is therefore a need to develop primary lithium cells of spirally-wound construction for high application temperatures, making it possible to maximize the yield of the positive electrode.

### SUMMARY OF THE INVENTION

The invention provides, firstly, an electrochemical cell comprising a container comprising an electrode plate group, said electrode plate group being in the shape of a spiral constituted by the winding of a structure obtained by superpositioning:
a positive electrode comprising active material selected from SOCl₂, SO₂, SO₂Cl₂; CFₓ with x≤1.5; MnO₂, FeS₂, V₂O₅, I₂, Bi₂O₃, Bi₂Pb₂O₅, CuCl₂, CuF₂, CuO, Cu₄O(PO₄)₂, CuS, FeS, MoO₃, Ni₃S₂, AgCl, Ag₂CrO₄, SVO, MO₆S₈, and a mixture of several of the above,
a separator;
a negative electrode comprising an active material consisting of lithium metal or lithium-based alloy;
wherein an outer face of the spiral, facing the container, is formed by the positive electrode; and that a strip of lithium or of a lithium-based alloy at least partially covers an inner face of the container.

According to one embodiment of the electrochemical cell, the container is cylindrical and the strip of lithium or lithium-based alloy occupies at least 75%, preferably at least 95%, of the circumference of the container.

According to one embodiment of the electrochemical cell, the active material of the positive electrode is chosen from CFₓ with x≤1.5; MnO₂, SOCl₂, SO₂, FeS₂.

According to one embodiment of the electrochemical cell, the active material is of the CFₓ type with x≤1.5.

According to one embodiment of the electrochemical cell, the active material of the negative electrode is a lithium-based alloy of formula LiM, where M is selected from the group consisting of Mg, Al, Si, B, Ge, Ga or a mixture of several thereof.

According to one embodiment of the electrochemical cell, the active material of the negative electrode is an alloy of the LiMg type.

According to one embodiment of the electrochemical cell, the cell is of the LiMg/CFₓ type with x≤1.5.

According to one embodiment of the electrochemical cell, the active material of the negative electrode of the spiral is arranged on the two faces of a current collector.

According to one embodiment of the electrochemical cell, the thickness of said strip of lithium or of a lithium-based alloy covering an inner face of the container represents at most 75% or at most 50% or at most 25% of the thickness of the active material of the negative electrode of the spiral.

According to one embodiment of the electrochemical cell, the ratio between the capacity of the negative electrode and the capacity of the positive electrode is greater than 1.

According to one embodiment of the electrochemical cell, the cell has a discharge yield greater than or equal to 70%, the yield being defined as the ratio between the capacity discharged by the cell at a rate of less than or equal to C/120 at a temperature of 200° C. and the theoretical capacity of the positive electrode or of the negative electrode having the lowest capacity.

According to one embodiment of the electrochemical cell, the diameter of the spiral is between 10 and 50 mm, preferably between 20 and 35 mm.

The invention also relates to the use of the electrochemical cell as defined above, in storage, in charge or in discharge at a temperature of at least 150° C.

The invention also provides a method for manufacturing an electrochemical cell as defined above, comprising at least the following steps:
a) placing the strip of lithium or lithium-based alloy up against an inner face of the container, so that the entire surface of the strip of lithium or lithium-based alloy will face the last turn of the electrode plate group formed by the positive electrode;
b) forming the electrode plate group in the shape of a spiral;
c) introducing the electrode plate group into the container obtained in step a);
d) performing electrical connection between the negative electrode and the current output negative terminal of the cell and performing electrical connection between the positive electrode and the current output positive terminal of the cell;
e) assembling a cover onto the container;
f) filling the cell with an electrolyte;
g) closing the cell.

The applicant has surprisingly discovered that the fact of distributing the total amount of lithium into two contributions, namely a first contribution at the spiral negative electrode and a second contribution at the strip of lithium at least partially covering an inner face of the container, makes it possible to increase the yield of the positive electrode, that is to say to increase the ratio between the actual discharge capacity of the cell and the theoretical (calculated) capacity in discharge of the cell, in the situation where it is the positive electrode which limits the capacity of the cell. Obtaining a better yield makes it possible to increase the electrochemical capacity of the cell, for equal amounts of active materials. In other words, it is possible to maintain an electrochemical capacity in discharge identical to that of a standard spirally-wound primary lithium cell, while using less positive and negative active materials. The invention makes it possible to reduce production costs since a smaller amount of positive and negative active materials is used for an identical restituted capacity of the cell.

### BRIEF DESCRIPTION OF THE DRAWINGS

FIG. 1 is a schematic representation of a cell 1 according to the invention comprising a positive electrode (a), and a negative electrode (b) wound together in the shape of a spiral and a lithium strip (c) covering the inner face of the container (d). The separator, although present in the cell, is not shown here, for the sake of ease of understanding.

FIG. 2 represents the discharged capacity of cells referred to as AO and AP during discharge at the respective rate of C/125 and C/116 at 200° C. under 135 mA after 48 h of storage at 150° C. of these cells.

FIG. 3 represents the discharged capacity of cells referred to as AO, AR1, AP3 and AQ1 during a discharge at the respective rate of C/125, C/125, C/116 and C/110, at 200° C. under 135 mA after 48 h of storage at 150° C. of these cells.

### DESCRIPTION OF THE EMBODIMENTS OF THE INVENTION

The first subject matter of the invention is an electrochemical cell comprising a container comprising an electrode plate group, said electrode plate group being in the shape of a spiral constituted by the winding of a structure obtained by superpositioning:
a positive electrode comprising active material selected from SOCl₂, SO₂, SO₂Cl₂; CFₓ with x≤1.5; MnO₂, FeS₂, V₂O₅, I₂, Bi₂O₃, Bi₂Pb₂O₅, CuCl₂, CuF₂, CuO, Cu₄O(PO₄)₂, CuS, FeS, MoO₃, Ni₃S₂, AgCl, Ag₂CrO₄, SVO, MO₆S₈, and a mixture of several of the above,
a separator;
a negative electrode comprising an active material consisting of lithium metal or lithium-based alloy;
wherein an outer face of the spiral, facing the container, is formed by the positive electrode; and a strip of lithium or of a lithium-based alloy at least partially covers an inner face of the container.

The electrochemical cell according to the invention as well as its various constituents will be described below.

### Container and Lithium Strip Pressed Against the Wall of the Container

The container of the electrochemical cell according to the invention may adopt various shapes compatible with a spirally-wound electrode plate group. Preferably, the container is cylindrical.

An inner face of the container is at least partially covered by a strip of lithium or of a lithium-based alloy.

According to one embodiment, this lithium or lithium alloy based strip occupies at least 75%, preferably at least 95% of the circumference of the container. Preferably, it occupies at least half of the internal height of the container, preferably at least 75%, more preferably at least 95% of the internal height of the container.

According to one embodiment, the lithium or lithium alloy-based strip can extend over from 95% to 105% of the height of the electrode plate group.

According to another embodiment, this lithium or lithium-based alloy strip completely covers an inner face of the container which is in contact with the electrode plate group.

The strip may be made of pure lithium or of a lithium-based alloy of formula LiM in which M is selected from the group consisting of Mg, Al, Si, B, Ge, Ga or a mixture of several thereof. Those skilled in the art will choose the alloy as a function of the environment in which the cell is used, in particular its temperature. Preferably, the strip of lithium or lithium-based alloy is made of pure lithium. The internal face of the container can be used as a current collector.

The thickness of said lithium strip or of the lithium-based alloy covering an inner face of the container represents at most 75% or at most 50% or at most 25%, or at most 15% of the thickness of the active material of the negative electrode of the spiral. Preferably, the thickness of the strip of lithium or lithium-based alloy represents from 45% to 55% of the thickness of the active material of the negative electrode of the electrode plate group.

The lithium-based or lithium-based alloy strip may have a thickness of between 0.1 and 0.6 mm or between 0.2 and 0.4 mm or between 0.2 and 0.3 mm.

The theoretical electrochemical capacity of the strip of lithium or lithium-based alloy may represent from 5% to 35% or from 10% to 30% or from 15% to 25% of the theoretical electrochemical capacity of the negative electrode of the electrode plate group.

### Positive Electrode (Cathode)

The active material of the positive electrode may be chosen from CFₓ with x≤1.5; MnO₂, SOCl₂, SO₂, SO₂Cl₂, FeS₂, V₂O₅, I₂, Bi₂O₃, Bi₂Pb₂O₅, CuCl₂, CuF₂, CuO, Cu₄O(PO₄)₂, CuS, FeS, MoO₃, Ni₃S₂, AgCl, Ag₂CrO₄, SVO, MO₆S₈, and a mixture of several of the above.

The electrochemical cell according to the invention may comprise a liquid cathode or a solid cathode.
a) The liquid cathode active material may be selected from SOCl₂, SO₂, SO₂Cl₂ or a mixture thereof. In this case, the positive electrode corresponds to a porous mass of carbon of large specific surface impregnated with an electrolyte. It is a support for the cathode reaction. The electrolyte may be either SO₂ dissolved in an organic solvent to which one or more lithium salts have been added, or SOCl₂, or SO₂Cl₂ added to one or more lithium salts. The porous carbon mass serves as a current collector and the carbon pores house the liquid cathode active material.
b) The solid cathode active material may be selected from CFₓ with x≤1.5; MnO₂, FeS₂, V₂O₅, I₂, Bi₂O₃, Bi₂Pb₂O₅, CuCl₂, CuF₂, CuO, Cu₄O(PO₄)₂, CuS, FeS, MoO₃, Ni₃S₂, AgCl, Ag₂CrO₄, SVO, MO₆S₈, or a mixture of several of the above.

According to one embodiment, the active material is CFₓ with x≤1.5, preferably with x lying between 0.2 and 1.1.

The positive electrode and the negative electrode are impregnated with a liquid organic electrolyte comprising:
one or more organic solvents of cyclic carbonate type (propylene carbonate (PC), ethylene carbonate (EC)), linear carbonates (dimethyl carbonate (DMC), diethyl carbonate (DEC), ethyl methyl carbonate (EMC), fluorinated or non-fluorinated (mono-fluoroethyl carbonate, etc.), glymes and derivatives (dimethoxyethane), furan (tetrahydrofuran) and its fluorinated derivatives, but also ionic liquids or any other solvent known in Li-ion or primary lithium technologies.
known lithium salts of lithium-ion and primary lithium technologies (LiPF₆, LiBF₄, lithium trifluoromethanesulfonimide LiN(CF₃SO₂)₂(LiTSFI), lithium bis(fluorosulfonyl)imide Li(FSO₂)₂N (LiFSI), lithium bis(oxalatoborate) LiBOB).
Optionally, additives commonly used in the field of lithium-ion and primary lithium batteries. These additives are in particular vinylene carbonate (VC), LiPO₂F₂, or any other additive making it possible to actively participate in the passivation of lithium, or else to allow the capture of water in the cell, also known as water scavengers.

According to another embodiment, the solid active material of the positive electrode may be arranged on a current collector which may or may not be a perforated metal, a grid, a metal fabric, a tape. The current collector may be made of a material chosen from copper, aluminum, stainless steel and nickel, preferably nickel.

The thickness of the current collector may be between 0.2 and 0.3 mm, preferably the thickness is approximately 0.25 mm.

The total thickness of the positive electrode may be 0.8 to 1.5 mm.

### Negative Electrode (Anode)

The negative electrode according to the invention comprises an active material made of lithium metal or of a lithium-based alloy.

The active material of the negative electrode may be a lithium-based alloy of formula LiM, where M is selected from the group consisting of Mg, Al, Si, B, Ge, Ga or a mixture of several thereof. Preferably, M is Mg.

The proportion of lithium in an alloy may be between 70 and 95%, preferably between 75 and 85% relative to the total weight of the alloy. Advantageously, the lithium may be present in the alloy in an amount of 75% relative to the total weight of the alloy.

According to one embodiment, the active material of the negative electrode may be arranged on one or two faces of a current collector. Preferably, the active material is deposited on the two faces of the current collector.

According to another embodiment, the current collector is chosen from the group comprising a metal strip in deployed or perforated form, a metal fabric, a tape, a grid. It consists of a material that can be chosen from copper, stainless steel and nickel, preferably nickel.

According to another embodiment, the active material of the negative electrode is not arranged on a current collector.

The thickness of the negative electrode may be between 0.1 and 0.8 mm, preferably between 0.2 and 0.3 mm. Advantageously, the thickness of the negative electrode is 0.25 mm.

### Separator

The material of the separator may be chosen from polyolefins, for example polypropylene, polyethylene, polyesters, glass fibers bonded by a polymer, polyimides, polyamides, polyaramide, polyamideimide and cellulose. The polyester may be chosen from polyethylene terephthalate (PET) and polybutylene terephthalate (PBT). Advantageously, the polyester or polypropylene or polyethylene contains or is coated with a material selected from the group consisting of a metal oxide, a carbide, a nitride, a boride, a silicide and a sulfide. This material may be SiO₂ or Al₂O₃.

Preferably, for high temperatures, the separator may be composed of glass fibers bonded by a polymer or a film of porous polymer the degradation temperature of which allows its use at high temperature (200° C. to 230° C.). The polymers capable of being used for this purpose may be chosen from para-aramid, PEEK (polyether ether ketone), PPS (polyphenylene sulfide) or a mixture of one or more of these polymers with cellulose or PAN (polyacrylonitrile).

### Electrode Plate Group

An electrode plate group is formed by interposing a separator between at least one positive electrode and at least one negative electrode.

The electrode plate group according to the invention is formed by the spiral winding of at least one positive electrode and at least one negative electrode separated by a separator.

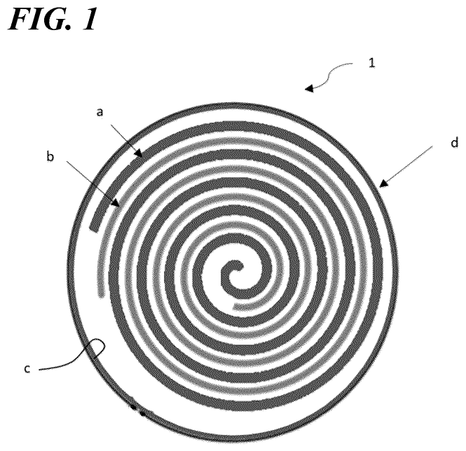

The electrode plate group is wound so that an outer face of the spiral, facing the container, is formed by the positive electrode. Thus, the positive electrode is facing the strip of lithium or lithium-based alloy at least partially covering an inner face of the container. FIG. 1 is a schematic representation of a cell 1 according to the invention comprising a positive electrode (a) and a negative electrode (b) wound together in the shape of a spiral and a lithium strip (c) covering an inner face of the container (d). The separator, although present in the cell, is not shown here, for the sake of ease of understanding.

The diameter of the spirally-wound electrode plate group may be between 10 and 50 mm, preferably between 20 and 35 mm, or between 25 and 30 mm, advantageously the diameter is 30 mm. The diameter of the electrode plate group is dependent on the diameter of the container. Thus, it is to be adapted as a function of the format chosen by a person skilled in the art. Formats A to F can be used.

Generally, the cells of the standard primary lithium type used at ambient temperature are limited by the capacity of the negative electrode, that is to say that the ratio between the capacity of the negative electrode and the capacity of the positive electrode is less than 1.

However, this type of cell is not suitable for high-temperature applications, for example starting from 150° C. due to the increased self-discharge of the lithium negative electrode caused by these high temperatures. In order to overcome this lithium loss, provision is made for the lithium to be present in excess so that consequently the cell is limited by the capacity of the positive electrode.

Thus, in the context of certain applications of the cell according to the invention at a temperature greater than 150° C. the ratio between the capacity of the negative electrode and the capacity of the positive electrode is reversed and is therefore greater than 1.

According to one embodiment, the cell according to the invention has a discharge yield greater than or equal to 70%, or greater than or equal to 72%, or greater than or equal to 73%, or greater than or equal to 74%, or greater than or equal to 75% or greater than or equal to 76%, or greater than or equal to 77%, or greater than or equal to 78%; performance or yield being defined as the ratio between the actual capacity discharged by the cell at a rate of less than or equal to C/120 at a temperature of 200° C. and the theoretical (calculated) capacity of the positive electrode and of the negative electrode having the lowest capacity, C being the nominal (theoretical) capacity of the cell.

### Manufacturing Process

The method for manufacturing the cell according to the invention comprises at least the steps consisting of:
a) placing the lithium or lithium-based alloy strip up against an inner face of the container, so that the entire surface of the strip of lithium or lithium-based alloy will face the last turn of the electrode plate group, formed by the positive electrode;
b) forming the electrode plate group into the shape of a spiral, preferably using a spiral-winding machine;
c) introducing the electrode plate group into the container obtained in step a);
d) producing an electrical connection between the negative electrode and the negative current output terminal of the cell and producing an electrical connection between the positive electrode and the positive current output terminal of the cell. Generally, the container is at the potential of the negative electrode and a protuberance on the cover of the cell is at the potential of the positive electrode;
e) assembling a cover on the container, for example by laser welding;
f) filling of the cell with the electrolyte;
g) closing of the cell.

According to one embodiment, in step f), the cover may include a filling hole through which the electrolyte is introduced. Once the electrolyte has been introduced, this filling hole is closed in step g) by a stainless-steel ball through an electrical weld of the ball on the hole.

### EXAMPLES

1) Two prototypes cells AO and AP were prepared. Each of them comprises a negative electrode made of LiMg alloy with 75% by weight of lithium and a positive electrode of CFₓ type. The electrode plate group is spiraled identically in the two prototypes AO and AP, and the capacity of these two cells is limited by the amount of CFₓ constituting the positive electrode. Prototype AO differs from the prototype AP according to the invention by the absence of the strip of lithium placed up against an inner face of the container and by the fact that the length of the negative electrode of the electrode plate group is elongated by 10% compared to the length of the negative electrode of the electrode plate group of the cell AP according to the invention. The discharge results at 200° C. of these two prototypes are presented in Table 1 below.

TABLE 1

| | Cell according to |
|---|---|
| Cell AO | the invention AP |

| | | |
|---|---|---|
| Li strip pressed against | No | Yes |

| | | | | |
|---|---|---|---|---|
| inner face of the container | | | | |
| Li capacity of electrode | 18.9 | Ah | 14 | Ah |
| plate group | | | | |

| | | | |
|---|---|---|---|
| Capacity of Li pressed | — | 2.9 | Ah |

| | | | | |
|---|---|---|---|---|
| against inner face | | | | |
| Total capacity of negative | 18.9 | Ah | 16.9 | Ah |
| electrode | | | | |
| CFx capacity | 17.1 | Ah | 15.7 | Ah |
| Theoretical cell capacity | 17.1 | Ah | 15.7 | Ah |
| Discharged capacity under | 11.5 | Ah | 11.4 | Ah |
| 0.135A at 200° C. | | | | |

| | | |
|---|---|---|
| Performance (yield) | 67% | 73% |

| | | | | |
|---|---|---|---|---|
| Diameter of electrode plate | 30 | mm | 29 | mm |
| group | | | | |

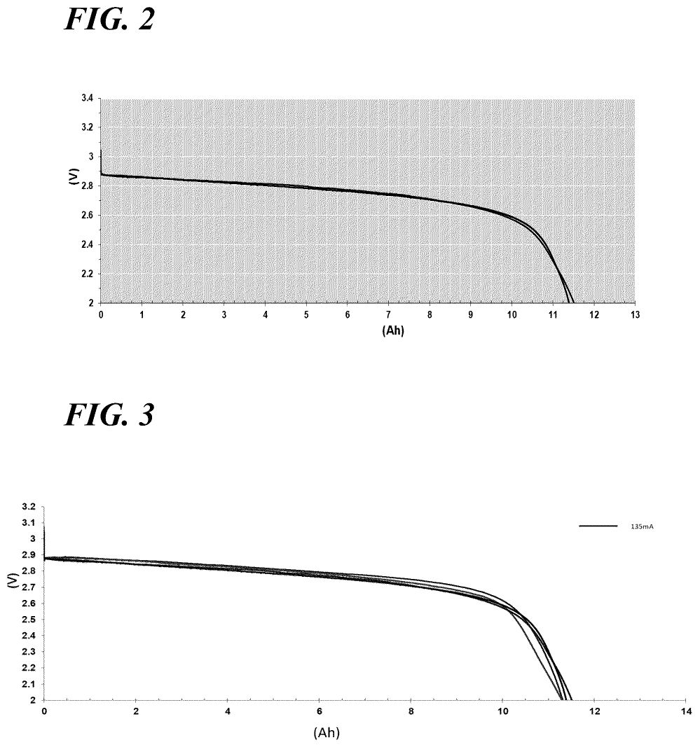

FIG. 2 shows the discharged capacity of the cells AO and AP during a discharge at the rate of C/125 for the prototype AO or C/116 for the prototype AP, at 200° C. under 135 mA after 48 h of storage at 150° C. It is observed that although the theoretical capacity of the cell AP according to the invention (15.7 Ah) is smaller by 9% relative to that of the cell AO (17.1 Ah), the capacity discharged under 135 mA at 200° C. is almost identical since they are respectively 11.4 Ah and 11.5 Ah. This means that with a smaller quantity of CFₓ and lithium, the cell AP according to the invention makes it possible to obtain a discharged capacity identical to that of the cell AO comprising more CFₓ and lithium.

Consequently, the discharge yield is higher in the case of the cell according to the invention (73% vs 67%).

The strip of lithium or lithium-based alloy pressed against an inner face of the container makes it possible to make use of an outer face of the positive electrode which forms the last turn of the spirally-wound electrode plate group. Thus, the positive electrode operates more homogeneously.

Other prototypes (AO, AR1, AQ1, AP3) have been designed according to the following characteristics:
Negative electrode made of LiMg alloy with 75% by weight of lithium;
Positive electrode in CFₓ;
Separator: either 2 separators of 380 μm thickness (prototypes AR1, AQ1), or 4 separators, of which 2 are 230 μm thick and 2 are 102 μm thick (prototypes AO, AP3).

TABLE 2

| | Cell with +10% negative | | Cell according | |
|---|---|---|---|---|
| | electrode length | | to the invention | |
| | Name of prototype | | | |
| | Proto AO | Proto AR1 | Proto AQ1 | Proto AP3 |
| Separator | 4 | 2 | 2 | 4 |
| | separators | separators | separators | separators |
| Li strip pressed | No | No | Yes | Yes |
| against inner face | | | | |
| Discharge | 200 | 200 | 200 | 200 |
| temperature (in | | | | |
| ° C.) | | | | |
| Total capacity of | 18.9 | 19.5 | 17.0 | 16.9 |
| negative electrode | | | | |
| (Ah) | | | | |
| Theoretical cell | 17.1 | 17.1 | 14.9 | 15.7 |
| capacity (Ah) | | | | |
| Actual capacity | 11.5 | 11.3 | 11.3 | 11.4 |
| discharged (Ah) | | | | |
| Performance | 67% | 66% | 76% | 73% |
| (yield) | | | | |

FIG. 3 shows the discharged capacity of the cells AO, AR1, AP3 and AQ1 during a discharge at 200° C. under 135 mA after 48 h of storage at 150° C. of these cells.

Comparing, firstly, AP3 and AO and, secondly, AQ1 and AR1 makes it possible to conclude that a significantly higher yield is obtained with the cell according to the invention (76% vs 66% and 73% vs 67%). This significant increase in yield is due to the presence of the strip of lithium or lithium-based alloy pressed against an inner face of the container.

Consequently, the alternative solution consisting in extending the length of the negative electrode by 10% in order to compensate for the fact that an outer turn constituted by the positive electrode is facing only one single anode turn does not make it possible to resolve the technical problem of the invention which is that of optimizing the work of the positive electrode.

1. An electrochemical cell comprising a container comprising an electrode plate group, said electrode plate group being in the shape of a spiral constituted by a winding of a structure obtained by superpositioning:
a positive electrode comprising active material selected from SOCl₂, SO₂, SO₂Cl₂; CFₓ with x≤1.5; MnOS₂, FeS₂, V₂O₅, I₂, Bi₂O₃, Bi₂Pb₂O₅, CuCl₂, CuF₂, CuO, Cu₄O(PO₄)₂, CuS, FeS, MoO₃, Ni₃S₂, AgCl, Ag₂CrO₄, SVO, MO₆S₈, and a mixture of several of the above,
a separator;
a negative electrode comprising an active material consisting of lithium metal or lithium-based alloy;
characterized in that an outer face of the spiral, facing the container, is formed by the positive electrode; and that a strip of lithium or of a lithium-based alloy at least partially covers an inner face of the container.

2. The electrochemical cell according to claim 1, wherein the container is cylindrical and the strip of lithium or of a lithium-based alloy occupies at least 75%, preferably at least 95%, of a circumference of the container.

3. The electrochemical cell according to claim 1, wherein the active material of the positive electrode is selected from the group consisting of CFₓ with x≤1.5; MnO₂, SOCl₂, SO₂; and FeS₂.

4. The electrochemical cell according to claim 3, wherein the active material is of CFₓ type with x≤1.5.

5. The electrochemical cell according to claim 1, wherein the active material of the negative electrode is a lithium-based alloy of formula LiM, wherein M is selected from the group consisting of Mg, Al, Si, B, Ge, Ga or a mixture of several thereof.

6. The electrochemical cell according to claim 5, wherein the active material of the negative electrode is an alloy of LiMg type.

7. The electrochemical cell according to claim 1, wherein the cell is of the LiMg/CFₓ type with x≤1.5.

8. The electrochemical cell according to claim 1, wherein the active material of the negative electrode of the spiral is arranged on two faces of a current collector.

9. The electrochemical cell according to claim 1, wherein a thickness of said strip of lithium or of a lithium-based alloy covering an inner face of the container is at most 75% or at most 50% or at most 25% of the thickness of the active material of the negative electrode of the spiral.

10. The electrochemical cell according to claim 1, wherein a ratio between the capacity of the negative electrode and the capacity of the positive electrode is greater than 1.

11. The electrochemical cell according to claim 1, having a discharge yield of greater than or equal to 70%, the yield being defined as the ratio between the capacity discharged by the cell at a rate of less than or equal to C/120 at a temperature of 200° C. and a theoretical capacity of whichever of the positive electrode or the negative electrode has the lowest capacity.

12. The electrochemical cell according to claim 1, wherein the diameter of the spiral is between 10 and 50 mm.

13. A method of using an electrochemical cell, comprising storing or charging or discharging the electrochemical cell as defined in claim 1, at a temperature of at least 150° C.

14. A method for manufacturing an electrochemical cell comprising a container comprising an electrode plate group, said electrode plate group being in the shape of a spiral constituted by a winding of a structure obtained by superpositioning:
a positive electrode comprising active material selected from SOCl₂, SO₂, SO₂Cl₂; CFₓ with x≤1.5; MnOS₂, FeS₂, V₂O₅, I₂, Bi₂O₃, Bi₂Pb₂O₅, CuCl₂, CuF₂, CuO, Cu₄O(PO₄)₂, CuS, FeS, MoO₃, Ni₃S₂, AgCl, Ag₂CrO₄, SVO, MO₆S₈, and a mixture of several of the above,
a separator;
a negative electrode comprising an active material consisting of lithium metal or lithium-based alloy;
characterized in that an outer face of the spiral, facing the container, is formed by the positive electrode; and that a strip of lithium or of a lithium-based alloy at least partially covers an inner face of the container, the method comprising at least the following steps:
a) placing the strip of lithium or lithium-based alloy up against an inner face of the container, so that the entire surface of the strip of lithium or lithium-based alloy will face the last turn of the electrode plate group formed by the positive electrode;
b) forming the electrode plate group in the shape of a spiral;
c) introducing the electrode plate group into the container obtained in step a);
d) performing electrical connection between the negative electrode and a current output negative terminal of the cell and performing electrical connection between the positive electrode and a current output positive terminal of the cell;
e) assembling a cover onto the container;
f) filling the cell with an electrolyte;
g) closing the cell.

15. The method of claim 14, wherein the cell is of the LiMg/CFₓ type with x≤1.5, and a ratio between the capacity of the negative electrode and the capacity of the positive electrode is greater than 1.

16. The electrochemical cell according to claim 1, wherein:
the cell is of the LiMg/CFₓ type with x≤1.5,
a ratio between the capacity of the negative electrode and the capacity of the positive electrode is greater than 1,
and having a discharge yield of greater than or equal to 70%, the yield being defined as the ratio between the capacity discharged by the cell at a rate of less than or equal to C/120 at a temperature of 200° C. and a theoretical capacity of whichever of the positive electrode or the negative electrode has the lowest capacity.
